(19) United States
(12) Patent Application Publication
(10) Pub. No.: US 2025/0138150 A1
(43) Pub. Date: May 1, 2025

(54) Range finding

(71) Applicant: Teknologian tutkimuskeskus VTT Oy, Espoo (FI)

(72) Inventors: Pasi Pyykönen, Espoo (FI); Pertti Peussa, Espoo (FI); Ari Virtanen, Espoo (FI); Matti Kutila, Espoo (FI)

(21) Appl. No.: 18/691,468

(22) PCT Filed: Sep. 8, 2022
(86) PCT No.: PCT/FI2022/050597

§ 371 Date: Mar. 13, 2024

(30) Foreign Application Priority Data
Sep. 13, 2021 (FI) 20215962

(51) Int. Cl. G01S 7/41

(52) U.S. Cl. CPC G01S 7/411

(57) ABSTRACT

According to an example aspect of the present invention, there is provided an apparatus configured at least to store information defining a set of reference areas, each reference area having a location, shape and geographic size, obtain range finding data which comprises plural data items, each data item having a location and a magnitude, allocate at least a part of the data items to the set of reference areas such that magnitudes of data items with locations in a same reference area are summed, and apply a threshold to select from among the reference areas a second set of reference areas with integrated magnitudes in excess of the threshold.

### FIELD

The present disclosure relates to managing range finding data, such as radar, lidar or other range finding data.

### BACKGROUND

Positioning of objects is often performed using satellite positioning, such as Global Navigation Satellite System (GNSS), i.e. GPS, or the Galileo constellation. Alternatively, positioning may be accomplished using positioning capabilities of a cellular communication network, for example.

An accurate positioning mechanism is needed for e.g. autonomous or semi-autonomous vehicles to ensure safety of persons in such vehicles and nearby routes traversed by such vehicles. Vehicular navigation applications also need positioning information to enable provision of meaningful navigation advice to drivers.

### SUMMARY

According to some aspects, there is provided the subject-matter of the independent claims. Some embodiments are defined in the dependent claims.

According to a first aspect of the present disclosure, there is provided an apparatus comprising at least one processing core, at least one memory including computer program code, the at least one memory and the computer program code being configured to, with the at least one processing core, cause the apparatus at least to store information defining a set of reference areas, each reference area having a location, shape and geographic size, obtain range finding data which comprises plural data items, each data item having a location and a magnitude, allocate at least a part of the data items to the set of reference areas such that magnitudes of data items with locations in a same reference area are summed, and apply a threshold to select from among the reference areas a second set of reference areas with integrated magnitudes in excess of the threshold.

According to a second aspect of the present disclosure, there is provided a method comprising storing information defining a set of reference areas, each reference area having a location, shape and geographic size, obtaining range finding data which comprises plural data items, each data item having a location and a magnitude, allocating at least a part of the data items to the set of reference areas such that magnitudes of data items with locations in a same reference area are summed, and applying a threshold to select from among the reference areas a second set of reference areas with integrated magnitudes in excess of the threshold.

According to a third aspect of the present disclosure, there is provided a non-transitory computer readable medium having stored thereon a set of computer readable instructions that, when executed by at least one processor, cause an apparatus to at least store information defining a set of reference areas, each reference area having a location, shape and geographic size, obtain range finding data which comprises plural data items, each data item having a location and a magnitude, allocate at least a part of the data items to the set of reference areas such that magnitudes of data items with locations in a same reference area are summed, and apply a threshold to select from among the reference areas a second set of reference areas with integrated magnitudes in excess of the threshold.

### BRIEF DESCRIPTION OF THE DRAWINGS

FIG. 1 illustrates an example system in accordance with at least some embodiments of the present invention;

FIGS. 2A and 2B illustrate landmark fitting in accordance with at least some embodiments of the present invention;

FIG. 3 illustrates an example apparatus capable of supporting at least some embodiments of the present invention;

FIG. 4 illustrates signalling in accordance with at least some embodiments of the present invention, and

FIG. 5 is a flow graph of a method in accordance with at least some embodiments of the present invention.

### EMBODIMENTS

An occupancy grid comprising reference areas, such as squares or hexes, is employed to assist in differentiating between landmarks and spurious reflections in range finding data. In detail, reflections in range finding data are allocated to reference areas of the grid, after which magnitudes of such reflections are summed to arrive at an integrated reflection magnitude for the, or each, reference area. The integrated reflection magnitude may be used in landmark-based navigation, and a threshold may be applied to integrated reflection magnitudes of reference areas to enable ignoring spurious reflections which do not affect navigation, for example.

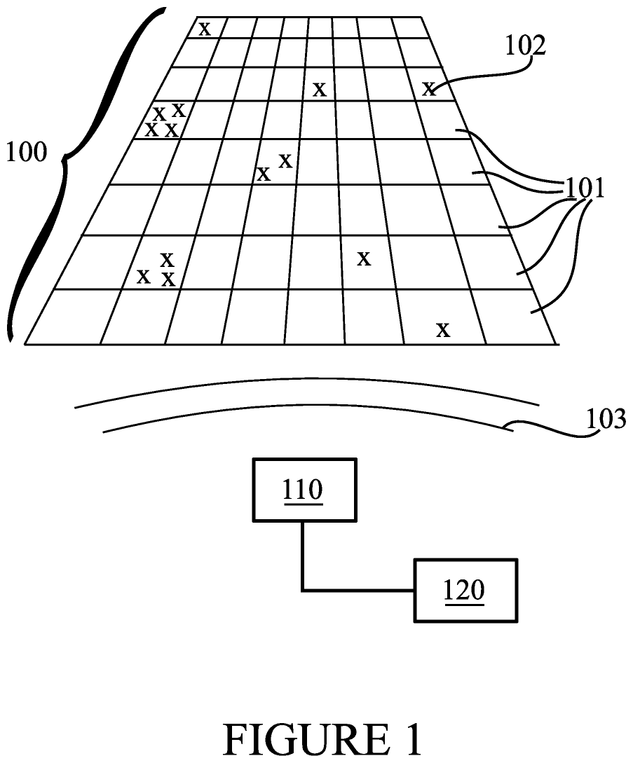

FIG. 1 illustrates an example system in accordance with at least some embodiments of the present invention. A range finding device 110, which may be a radar or lidar device, for example, emits energy 103 and records range finding data based on reflection of energy 103 from targets within a field of view of range finding device 110. To accomplish this, range finding device 110 has a transmitter to transmit energy 103, and a receiver to detect the portion of energy 103 which is reflected back toward range finding device 110. Alternatively to, or additionally to, a radar or lidar the range finding device may be a sonar, for example. In general, a single pulse of energy 103 transmitted from range finding device 110 may produce a large number of distinct reflections from a plural items 102 in the field of view. An advantage of using radar is that it is resilient to changes in weather. Radar also has a good accuracy in measuring the directions from which reflections arrive back at the radar.

A suitable radar may operate in the 24 GHz and/or 77 GHz band, for example. A radar as used herein may use more than one frequency. In some embodiments, a hyperspectral range finding device 110 is used.

Range finding device 110 generates range finding data when used. Range finding data comprises plural data items, each data item having a location and a magnitude. Each data item characterizes detection of an item 102. Each data item represents a detected reflection of energy 103 which is received back in range finding device 110. Reflections may occur from objects such as buildings, vehicles, lamp posts and items of trash on the ground, as well as from humans and animals in the field of view of range finding device 110. As a human may generate plural reflections, the human may be visible in the range finding data as a set of items 102, which are clustered together geographically.

The location in each data item may be expressed in a suitable manner, for example, it may be expressed in terms of Cartesian coordinates x, y in a coordinate system in the field of view of the range finding device. Alternatively, the location in the field of view may be expressed in terms of a distance from range finding device 110 and a sweep angle fixing a direction in which the corresponding item 102 is located, for example.

The magnitude in each data item indicates the strength of the reflection as recorded in range finding device 110. In case the range finding device 110 is a radar, the magnitude may be referred to as a radar cross section. In general a large, reflective item 102 produces a strong reflection and thus high magnitude, however the shape of the item 102 and environmental conditions may affect the exact magnitude and a single large item 102 may produce more than one reflection, causing more than one data item in the range finding data.

In the system of FIG. 1, a grid 100 is defined. Grid 100 comprises a set of reference areas 101, which are squares in the system of FIG. 1, but which may be hexagonal reference areas, or reference areas of another shape, depending on the specific implementation. In the grid of FIG. 1 the reference areas 101 are adjacent to each other in that there is no space between the neighbouring reference areas 101. In other embodiments, neighbouring reference areas 101 may have space between them which may be useful in use cases where it is known that no items 102 of interest are in certain areas of the field of view of the range finding device. For example, in these use cases reference areas 101 may cover roads or corridors of motion, whereas a forest or building block next to the road may be un-overlaid with reference areas 101. Grid 100 may be referred to as an occupancy grid.

Each reference area 101 has a location, a shape and a geographic size. Information defining the set of reference areas may define that all the reference areas 101 are square, for example, of the same size. In such a case, the locations of the squares may be defined in an x, y coordinate system. In a more general case, the reference areas 101 of grid 100 may be of differing sizes and/or shapes. For example, reference areas 101 directly in front of a vehicle may be smaller, with larger reference areas in more peripheral areas. When reference areas 101 are squares or hexagons, their side may be 10, 20 or 30 centimetres, for example. In some cases, grid 100 may be 100 or 200 metres in length and/or depth, for example.

Once range finding device 110 obtains the range finding data, the range finding device, an apparatus, such as a vehicle or vehicle part in which the range finding device is comprised in or a separate computing substrate 120 may allocate the data items of the range finding data, or at least a part of them, to the reference areas. Only part of the data items of the range finding data may be allocated, for example, in case some of the items 102 are not in reference areas 101 of grid 100.

In detail, the allocating may comprise, for each data item to be allocated, determining the reference area 101 inside which the location of the data item is comprised. Depending on the implementation, this determining may require a suitable coordinate transformation to be performed. If item 102 is in a specific reference area 101, then the reflection of energy 103 created by this item 102 is localized by range finding device 110 to a location which is within this specific reference area 101. This location may be correlated with the location, size and shape of the reference areas 101 to find out which one of the reference areas 101 contains the location of the data item and thus also the location of item 102 corresponding to the data item.

Once the data items of the range finding data are allocated to the reference areas 101, or during the allocation, the magnitudes of the data items in each reference area 101 are summed together. In this regard, the summing may include all data items so mapped, even if their magnitude is very low. In some embodiments scaling to a suitable range, such as 0-100, is performed to avoid overflow of the summed value. Such scaling may be performed, for example, as a sum over i in the following: summedMagnitude=summedMagnitude+(dataltemMagnitude[i]/maxValue)*100. Here maxValue is a maximum output magnitude value of the range finding device and dataItemMagnitude is the actually sensed reflection magnitude for a data item.

In some embodiments, the summing includes summing magnitudes of data items from more than one sweep or pulse of the range finding device. In some embodiments, the summing includes summing magnitudes of data items from more than one pulse of the range finding device, the range finding device being a radar, the pulses being of different frequencies.

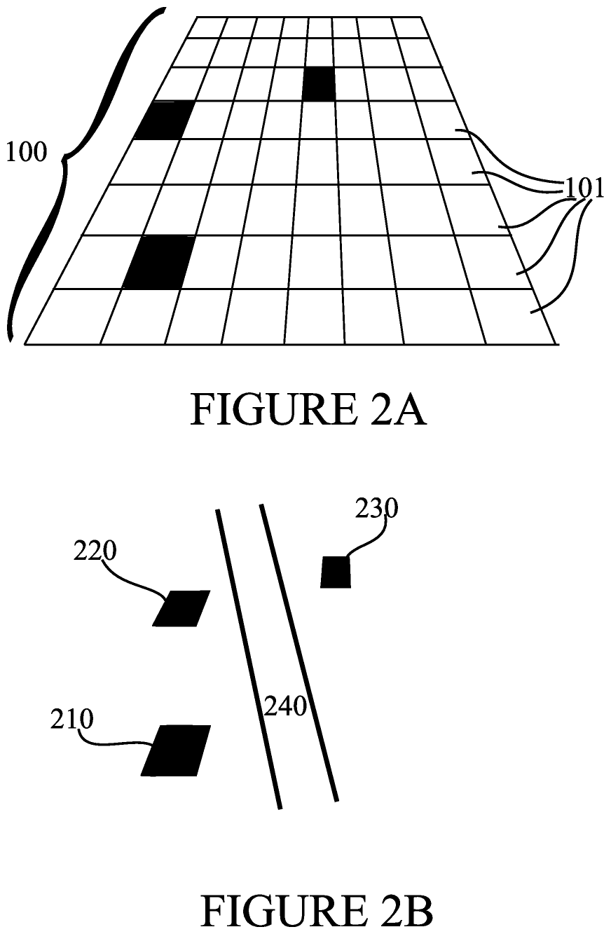

After summing the magnitudes, a threshold may be applied to the reference areas 101 to select the ones from among the reference areas 101 with summed magnitudes exceeding the threshold. The thus selected reference areas form a second set of reference areas. These reference areas 101, that is, the second set of reference areas, may be subsequently considered landmark candidates, as will be explained in more detail with reference to FIG. 2. Landmark-based navigation may be employed in autonomous or semi-autonomous vehicles, such as cars, for example. In the allocating, the data items may be associated with the reference areas by linking them to, or placing them in, a data structure which has a similar structure as the set of reference areas. Alternatively, links to the set of reference areas may be established from the data items to accomplish the allocation.

In some embodiments, the landmark-based navigation using range finding data is employed as a response to a determination that satellite positioning is unavailable, due to outage, an indoor context or jamming, for example.

In addition to landmark recognition, the disclosed system may be used to detect humans. In detail, a human may appear in radar data as a localized set of several low-magnitude reflections. Even the sum of these reflections is not necessarily very high in radar cross section, but the presence of several reflections close to each other may be considered a potential detection of a human. Therefore, once the magnitudes are summed into the reference areas, separately it may be considered if a reference area has a number of data items exceeding a human-detection threshold, even if the summed magnitude of the reference area 101 doesn't exceed the threshold for landmark detection, as discussed above. In some embodiments, the threshold for landmark selection is employed also in human detection, and in yet further embodiments a separate, lower, threshold is employed in human detection. A user may be presented a warning to check if a human is present, in case the human is potentially in danger of being run over by a vehicle, for example. The cluster of reflections created by a human may span a few adjacent reference areas 101, depending on the size of the reference areas.

FIGS. 2A and 2B illustrate landmark fitting in accordance with at least some embodiments of the present invention. The grid 100 of FIG. 2A corresponds to the grid 100 of FIG. 1. The items 102 are not illustrated in FIG. 2, rather, the reference areas 101 with summed magnitudes exceeding the landmark detection threshold are coloured black. In other words, the black reference areas 101 are landmark candidates, that is, the second set of reference areas. As can be inferred by referring to the grid of FIG. 1, one of the landmark candidates of the second set contained four reflections in FIG. 1, another one three reflections and the third one a single reflection, with a magnitude exceeding the landmark detection threshold on its own. The single reflection may be from a metallic pole, for example.

The grid is thus used to both remove duplicate detections of the same object, and to accumulate reflected energy from an object to increase the likelihood it is detected from the range finding data.

FIG. 2B illustrates known landmarks in the area where the range finding data was obtained. The general area where the apparatus 110 or 120 is located in may be known from inertial data, potentially in combination with satellite positioning data prior to the satellite positioning becoming unavailable, for example. Landmark data may comprise specific locations of at least one landmark, optionally also including expected relative magnitudes of the landmarks. The landmark data may also characterize how a magnitude of a landmark develops as a function of the angle from which it is detected. In other words, some landmarks may have a larger magnitude, such as radar cross section, in a specific direction and this may be used in matching a detected landmark candidate with landmark data. In the landmark data illustrated in FIG. 2B, three landmarks 210, 220, 230 are present as is road 240.

The landmark data may be fitted, or matched, to the detected landmark candidates, that is, to the second set of reference areas, for example in a least-squares sense, to obtain an alignment of the landmark candidates with landmarks recorded in the landmark data. In the situation of FIGS. 2A and 2B, aligning the landmark candidates with the landmarks in the landmark data enables using road 240 since the landmark data specifies the location of road 240 with respect to landmarks 210, 220 and 230. The three landmark candidates in FIG. 2A align well with the landmarks in FIG. 2B. For example, the relative distances and angles between the landmarks and the landmark candidates are the same, which yield a highly reliable match.

It should be emphasized that the landmark candidates of the second set may include spurious candidates owing to transient events such as parked cars or tractors, for example, Likewise, a landmark, despite being present in the field of view, may be missed in the range finding data if, for example, an energy-absorbing element is between range finding device 110 and the landmark, causing the summed magnitude from the landmark to fall short of the landmark detection threshold. However, in case plural landmarks are used these issues do not prevent aligning the candidates with actual landmarks. In some cases, even a single landmark may be aligned in case the surroundings are not very cluttered.

An important example in landmark fitting is a landmark pattern, such as metallic poles installed along the side of a road, with constant intervals between the poles. In such a case, a road, for example, may be detected by aligning the pattern of landmarks to a pattern of landmark candidates, without matching individual ones of the landmarks to individual candidates.

In fitting the landmark candidates of the second set to known landmarks, an optimization algorithm may be used, such as the simplex method, Newton's method or the Levenberg-Marquardt algorithm, for example. Landmark locations, or landmark pattern parameters, may be obtained from a database external to range finding device 110 or computing substrate 120.

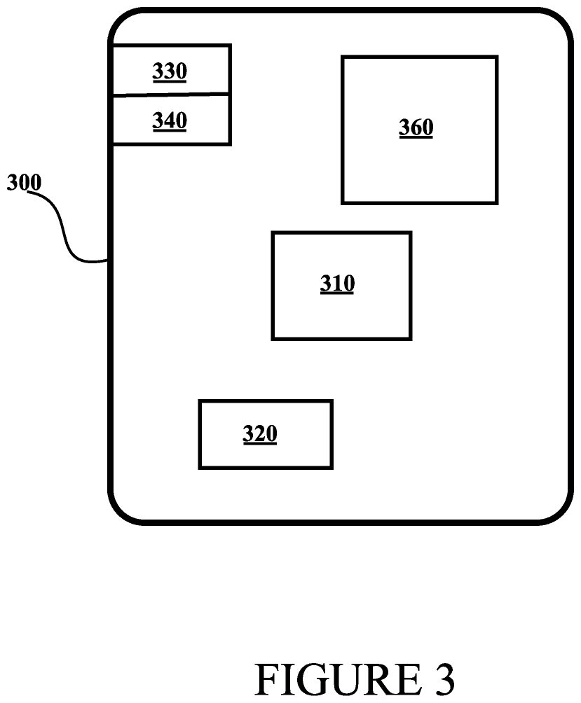

FIG. 3 illustrates an example apparatus capable of supporting at least some embodiments of the present invention. Illustrated is device 300, which may comprise, for example, a range finding device 110 or computing substrate 120 of FIG. 1, for example. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Core processor. Processor 310 may comprise at least one application-specific integrated circuit, ASIC. Processor 310 may comprise at least one field-programmable gate array, FPGA. Processor 310 may be means for performing method steps in device 300, such as storing, obtaining, allocating and applying. Processor 310 may be configured, at least in part by computer instructions, to perform actions.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure navigation parameters or thresholds.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver. Device 300 may comprise further devices not illustrated in FIG. 3.

Processor 310, memory 320, transmitter 330, receiver 340 and/or UI 360 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

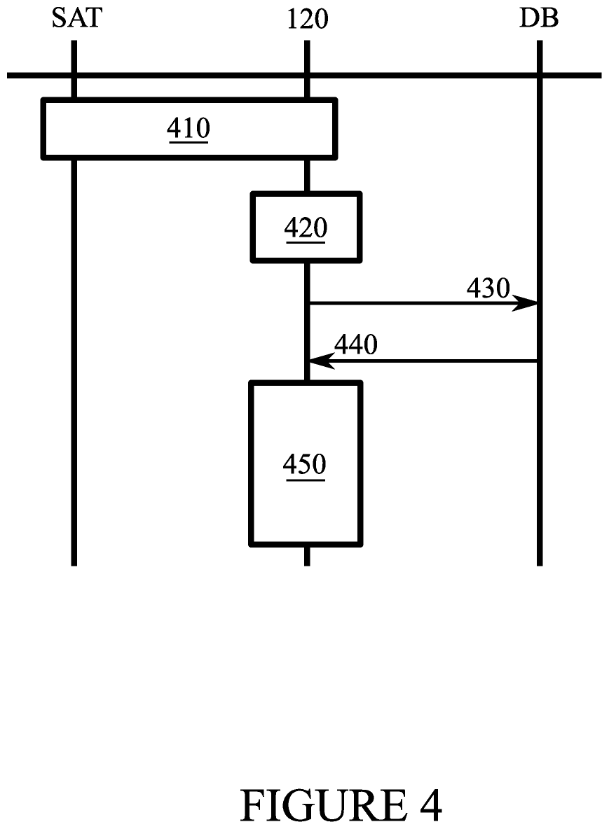

FIG. 4 illustrates signalling in accordance with at least some embodiments of the present invention. On the vertical axes are disposed, on the left, a satellite navigation constellation SAT, in the centre, computing substrate 120 and on the right, a landmark database DB. Time advances from the top toward the bottom. In the embodiments of FIG. 4, computing substrate 120 is installed in a car.

In phase 410, the car navigates using positioning from satellite constellation SAT. For example, computing substrate 120 may provide a graphical map display to the driver with turn advice. In phase 420, computing substrate 120 determines that sufficient data is no longer available from satellite navigation, and responsively computing substrate 120 requests local landmark information from database DB. The request of phase 430 may comprise a most recent location of computing substrate 120 as determined by satellite navigation before connection to satellite navigation was lost, for example.

In phase 440, database DB responsively provides the requested landmark information to computing substrate 120. Subsequently, in phase 450, computing substrate 120 uses the landmark-based navigation method as described herein above in connection with FIGS. 2A and 2B. To enable this, the car is also equipped with a range finding device 110, as described herein above in connection with FIG. 1.

The herein disclosed mechanism enables vehicles, such as autonomous vehicles, to use landmarks for positioning more accurately than with merely filtering radar detections. Accumulating the magnitudes enabled use of the method also in environments where apparent magnitude of landmarks changes as e.g. the landmarks get dirty or suffer damage. Detecting humans is also rendered more dependable by analysing the number of reflections, as discussed herein above.

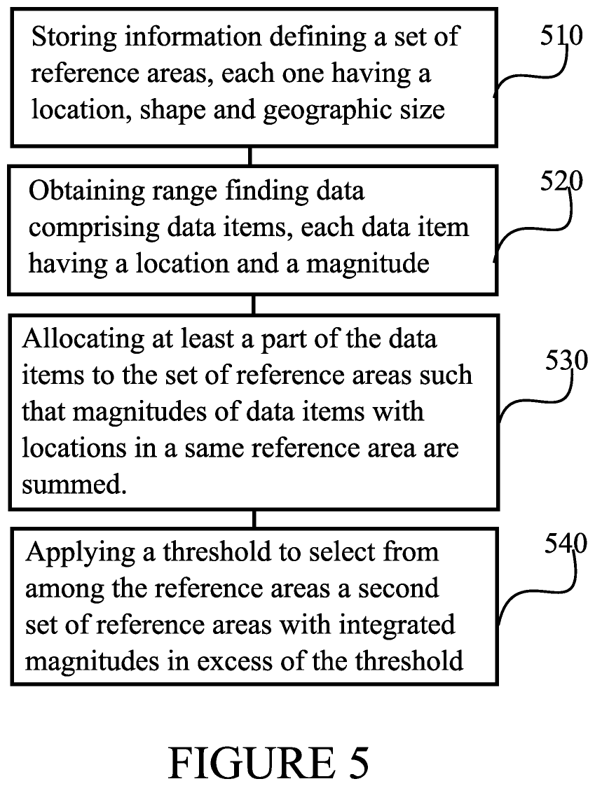

FIG. 5 is a flow graph of a method in accordance with at least some embodiments of the present invention. The phases of the illustrated method may be performed in computing substrate 120, a vehicle, or in a control device configured to control the functioning thereof, when installed therein.

Phase 510 comprises storing information defining a set of reference areas, each reference area having a location, shape and geographic size. Phase 520 comprises obtaining range finding data which comprises plural data items, each data item having a location and a magnitude. Phase 530 comprises allocating at least a part of the data items to the set of reference areas such that magnitudes of data items with locations in a same reference area are summed. Finally, phase 540 comprises applying a threshold to select from among the reference areas a second set of reference areas with integrated magnitudes in excess of the threshold.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in managing range finding data.

### ACRONYMS LIST

GPS global positioning system

1. An apparatus comprising at least one processing core, at least one memory including computer program code, the at least one memory and the computer program code being configured to, with the at least one processing core, cause the apparatus at least to:
store information defining a set of reference areas, each reference area having a location, shape and geographic size;
obtain range finding data which comprises plural data items, each data item having a location;
allocate at least a part of the data items to the set of reference areas such that data items with locations in a same reference area are summed, wherein
each data item has a magnitude indicating a strength of a reflection as recorded by a range finding device, the summing of the data items comprises summing their magnitudes to obtain integrated magnitudes, the apparatus is configured to apply a threshold to select from among the reference areas a second set of reference areas with the integrated magnitudes in excess of the threshold, and
match locations of reference areas of the second set to known landmark locations, and employ the second set of reference areas in vehicular landmark-based navigation.

2. The apparatus according to claim 1, wherein the range finding data is radar data or lidar data.

3. The apparatus according to claim 1, wherein the apparatus is configured to match a pattern of locations of at least two or three reference areas of the second set to a pattern of the known landmark locations.

4. The apparatus according to claim 1, wherein the apparatus is configured to obtain the known landmark locations from a database which is external to the apparatus.

5. The apparatus according to claim 1, wherein the apparatus is configured to classify those reference areas from among the second set into which several data items with a magnitude less than a second threshold were allocated as potential locations of humans.

6. The apparatus according to claim 1, wherein the allocating of the at least the part of the data items to the set of reference areas does not include use of a magnitude threshold.

7. The apparatus according to claim 1, wherein the vehicular landmark-based navigation is navigation of an automobile.

8. The apparatus according to claim 1, wherein the apparatus is configured to obtain the range finding data and to select the second set of reference areas responsive to a determination that satellite navigation is not available.

9. A method performed by an apparatus, comprising:
storing information defining a set of reference areas, each reference area having a location, shape and geographic size;
obtaining range finding data which comprises plural data items, each data item having a location, and
allocating at least a part of the data items to the set of reference areas such that data items with locations in a same reference area are summed, wherein
each data item has a magnitude indicating a strength of a reflection as recorded by a range finding device, the summing of the data items comprises summing their magnitudes to obtain integrated magnitudes, the method further comprises applying a threshold to select from among the reference areas a second set of reference areas with the integrated magnitudes in excess of the threshold, and
matching locations of reference areas of the second set to known landmark locations, and employing the second set of reference areas in vehicular landmark-based navigation.

10. The method according to claim 9, wherein the range finding data is radar data or lidar data.

11. The method according to claim 9, wherein the matching comprises matching a pattern of locations of at least two or three reference areas of the second set to a pattern of the known landmark locations.

12. The method according to claim 9, further comprising obtaining the known landmark locations from a database which is external to the apparatus.

13. The method according to claim 9, further comprising classifying those reference areas from among the second set into which several data items with a magnitude less than a second threshold were allocated as potential locations of humans.

14. The method according to claim 9, wherein the allocating of the at least the part of the data items to the set of reference areas does not include use of a magnitude threshold.

15. The method according to claim 9, wherein the vehicular navigation is navigation of an automobile.

16. The method according to claim 9, wherein the obtaining of the range finding data and the selecting of the second set of reference areas is performed responsive to a determination that satellite navigation is not available.

17. A non-transitory computer readable medium having stored thereon a set of computer readable instructions that, when executed by at least one processor, cause an apparatus to at least:
store information defining a set of reference areas, each reference area having a location, shape and geographic size;
obtain range finding data which comprises plural data items, each data item having a location, and
allocate at least a part of the data items to the set of reference areas such that data items with locations in a same reference area are summed, wherein
each data item has a magnitude indicating a strength of a reflection as recorded by a range finding device, the summing of the data items comprises summing their magnitudes to obtain integrated magnitudes, the set of computer readable instructions, when executed, further cause the apparatus to apply a threshold to select from among the reference areas a second set of reference areas with the integrated magnitudes in excess of the threshold, match locations of reference areas of the second set to known landmark locations, and employ the second set of reference areas in vehicular landmark-based navigation.
